(19) United States
(12) Patent Application Publication
(10) Pub. No.: US 2025/0296862 A1
(43) Pub. Date: Sep. 25, 2025

(54) ULTRA-HIGH-CONCENTRATION SEAWATER DESALINATION PROCESS FOR VALUABLE MINERAL RECOVERY AND HIGH-PURITY FRESHWATER PRODUCTION

(71) Applicant: KOREA INSTITUTE OF OCEAN SCIENCE & TECHNOLOGY, Busan (KR)

(72) Inventors: Ho Saeng LEE, Sokcho-si (KR); Ho JI, Goseong-gun (KR); Young Deuk KIM, Hwaseong-si (KR)

(73) Assignee: KOREA INSTITUTE OF OCEAN SCIENCE & TECHNOLOGY, Busan (KR)

(21) Appl. No.: 19/228,251

(22) Filed: Jun. 4, 2025

Related U.S. Application Data
(63) Continuation of application No. PCT/KR2023/016576, filed on Oct. 24, 2023.

(30) Foreign Application Priority Data
Dec. 8, 2022 (KR) 10-2022-0170650

(51) Int. Cl. C02F 9/00; B01D 3/14; B01D 9/00; C02F 1/04; C02F 1/20; C02F 1/28; C02F 1/38; C02F 1/52; C02F 103/08; C25B 15/08

(52) U.S. Cl. CPC C02F 9/00; B01D 3/146; B01D 9/00; C25B 15/085; B01D 2009/0086; C02F 1/04; C02F 1/20; C02F 1/28; C02F 1/38; C02F 2001/5218; C02F 2103/08; C02F 2301/08

(57) ABSTRACT

Provided is an ultra-high-concentration seawater desalination process for valuable mineral recovery and high-purity freshwater production. The process includes introducing seawater through a seawater inlet; performing pre-treatment by deaerating the introduced seawater; introducing the pretreated seawater into a seawater concentrator; introducing the seawater concentrated in the seawater concentrator into a concentrated water crystallizer to extract/recover solids (valuable mineral salts); re-introducing the concentrated water produced in the concentrated water crystallizer into the seawater concentrator; and subjecting distilled water discharged from the seawater concentrator to electrolysis treatment (water electrolysis) to produce hydrogen (H2). The present invention provides an ultra-high-concentration seawater desalination process for valuable mineral recovery and high-purity freshwater production, which can minimize the amount of seawater intake, can reduce energy costs of recovering valuable minerals, and can produce high-purity freshwater even under ultra-high-concentration conditions and thus can be used for hydrogen production through a water electrolysis process.

### CROSS-REFERENCE TO RELATED APPLICATIONS

This application is a continuation of International Application No. PCT/KR2023/016576 filed on Oct. 24, 2023, which claims priority to Korean Patent Application No. 10-2022-0170650 filed on Dec. 8, 2022, the entire contents of which are herein incorporated by reference.

### TECHNICAL FIELD

The present invention relates to a seawater desalination process, and more particularly, to a novel concept of an ultra-high-concentration seawater desalination process capable of producing high-purity freshwater for hydrogen generation and recovering valuable minerals from highly concentrated brine, the process comprising a low-energy, high-efficiency, and environmentally friendly seawater concentrator (multi-effect adsorption desalination, MEAD) and a concentrated water crystallizer (forced circulation separator+centrifuge).

### BACKGROUND ART

Recently, various technologies for desalinating different types of seawater, including deep ocean water, and producing mineral water therefrom have been actively developed.

Since the mineral components contained in deep ocean water are water-soluble, they are easily absorbed by the human body, making them a highly useful source of minerals for modern people.

Common seawater desalination methods include membrane distillation (evaporation), evaporation, electrodialysis, and reverse osmosis (RO). Among these, reverse osmosis, which is most widely used, is a process in which freshwater is obtained by applying pressure greater than the osmotic pressure to the feed water using a high-pressure pump after pre-treatment. However, since high pressure increases the flux, it also results in significant fouling. To maintain the desired flux despite the fouling, even higher pressure is required, leading to high energy consumption as a drawback.

The basic principle of the evaporation method is to separate freshwater from seawater by utilizing the property that only the solvent evaporates while the solute remains when a solution is evaporated. When seawater or brine is heated to its boiling point using a high-temperature heat source such as steam, the solvent (water) evaporates and becomes vapor. This vapor is then condensed using a low-temperature heat source (such as cooling water) to obtain freshwater. However, this method inevitably leads to scale formation on the heating tubes, which requires chemical cleaning, and it also has the disadvantage of high energy consumption per unit of freshwater produced.

The electrodialysis method (ED) is based on the selective movement of ions present in seawater. It employs membranes that contain fixed ionic groups and consists of cation exchange membranes and anion exchange membranes. Although electrodialysis-based desalination plants were developed and used about ten years earlier than those using reverse osmosis, the development of membranes and modules has been slower, and its range of applications is limited. As a result, electrodialysis is currently less widely used than reverse osmosis in the field of desalination.

The membrane distillation (MD) process is a desalination method in which seawater is heated to generate vapor, which then passes through a membrane to separate the seawater from the vapor. The vapor is subsequently condensed to produce freshwater. However, this method has drawbacks in that organic and other fouling substances can adhere to the membrane, slowing down the production rate, and in some cases, the membrane may fail to properly filter the seawater, resulting in poor-quality freshwater.

Meanwhile, conventionally, in order to extract and separate mineral components from seawater, seawater has been evaporatively concentrated through desalination processes such as those described above, and minerals such as calcium and magnesium have been separated in the form of salts by utilizing differences in solubility.

However, when separating dissolved mineral components from seawater using the above methods, the recovery rate of the minerals is low, and proper separation is difficult. In addition, chemical cleaning is required due to issues such as scaling, and energy consumption is also significantly high.

### PRIOR ART DOCUMENTS

### Patent Documents

(Patent Document 1) Korean Patent No. 10-1791621 (Title: Apparatus of membrane distillation desalination and concentrating extraction from seawater using heat pump, Registration Date: Oct. 24, 2017)
(Patent Document 2) Korean Patent No. 10-1639848 (Title: The manufacturing process of high hardness drinking water using NF/RO/ED membrane connection system, Registration Date: Jul. 8, 2016)

### SUMMARY

### Technical Problem

The present invention was made to overcome the above-mentioned problems, and one object of the present invention is to provide an ultra-high-concentration seawater desalination process for valuable mineral recovery and high-purity freshwater production that can minimize the seawater intake volume.

Another object of the present invention is to provide an ultra-high-concentration seawater desalination process for valuable mineral recovery and high-purity freshwater production that can reduce the energy costs of valuable mineral recovery.

Another object of the present invention is to provide an ultra-high-concentration seawater desalination process for valuable mineral recovery and high-purity freshwater production that enables the production of high-purity freshwater even under ultra-high-concentration conditions and can be utilized for hydrogen production through a water electrolysis process.

The technical tasks of the present invention are not limited to those mentioned above, and other technical tasks not described herein will be clearly understood by those skilled in the art from the following description.

### Technical Solution

In order to achieve the above tasks, an ultra-high-concentration seawater desalination process for valuable mineral recovery and high-purity freshwater production according to a preferred embodiment of the present invention is characterized by comprising: introducing seawater through a seawater inlet; performing pre-treatment by deaerating the introduced seawater; introducing the pretreated seawater into a seawater concentrator; introducing the seawater concentrated in the seawater concentrator into a concentrated water crystallizer to extract/recover solids (valuable mineral salts); re-introducing the concentrated water produced in the concentrated water crystallizer into the seawater concentrator; and subjecting distilled water discharged from the seawater concentrator to electrolysis treatment (water electrolysis) to produce hydrogen (H2).

In addition, the seawater concentrator of the ultra-high-concentration seawater desalination process for valuable mineral recovery and high-purity freshwater production according to a preferred embodiment of the present invention is characterized by comprising a multi-effect adsorption desalination (MEAD).

In addition, the concentrated water crystallizer of the ultra-high-concentration seawater desalination process for valuable mineral recovery and high-purity freshwater production according to a preferred embodiment of the present invention is characterized by comprising a forced circulation separator and a centrifuge.

### Advantageous Effects

According to an embodiment of the present invention, it is possible to provide an ultra-high-concentration seawater desalination process for valuable mineral recovery and high-purity freshwater production, which can minimize the intake amount of seawater.

Also, according to an embodiment of the present invention, it is possible to provide an ultra-high-concentration seawater desalination process for valuable mineral recovery and high-purity freshwater production, which can reduce the energy cost for recovering valuable minerals.

Also, according to an embodiment of the present invention, it is possible to provide an ultra-high-concentration seawater desalination process for valuable mineral recovery and high-purity freshwater production, which enables the production of high-purity freshwater even under ultra-high-concentration conditions and can thus be used for hydrogen production through a water electrolysis process.

The effects of the present invention are not limited to the above-mentioned effects, and other effects not explicitly described herein will be clearly understood by those skilled in the art from the description of the claims.

### DESCRIPTION OF DRAWINGS

FIG. 1 is a graph illustrating the change in brine concentration according to temperature within an evaporator of an adsorption multi-effect evaporation concentration process included in an ultra-high-concentration seawater desalination process for valuable mineral recovery and high-purity freshwater production, according to a preferred embodiment of the present invention.

FIG. 2 is a process diagram conceptually illustrating an ultra-high-concentration seawater desalination process for valuable mineral recovery and high-purity freshwater production, according to a preferred embodiment of the present invention.

FIG. 3 is a graph illustrating the change in brine concentration over time in an evaporator of the adsorption desalination process included in the ultra-high-concentration seawater desalination process for valuable mineral recovery and high-purity freshwater production, according to a preferred embodiment of the present invention.

FIG. 4 is a chart illustrating the water quality of freshwater produced from the adsorption desalination process included in the ultra-high-concentration seawater desalination process for valuable mineral recovery and high-purity freshwater production, according to a preferred embodiment of the present invention.

### DETAILED DESCRIPTION

Hereinafter, a preferred embodiment of the present invention will be described in detail with reference to the accompanying drawings so that those of ordinary skill in the art to which the present invention pertains can easily carry out the invention.

In the following description of the embodiment, well-known technical details in the art to which the present invention pertains and technical content not directly related to the present invention will be omitted. This is to clearly convey the gist of the present invention without obscuring it with unnecessary explanations.

For the same reason, certain components in the accompanying drawings are exaggerated, omitted, or schematically illustrated. Moreover, the sizes of the individual components do not necessarily reflect their actual dimensions. In the drawings, the same or corresponding components are denoted by the same reference numerals.

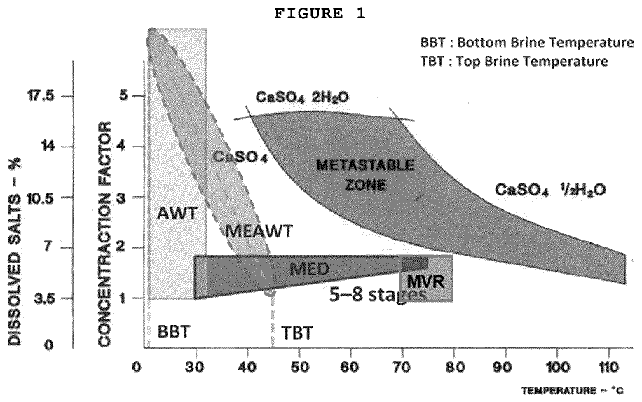

FIG. 1 is a graph showing the brine temperature inside the evaporator according to changes in brine concentration in the adsorption desalination (concentration) process included in the ultra-high-concentration seawater desalination process for valuable mineral recovery and high-purity freshwater production according to a preferred embodiment of the present invention.

Referring to FIG. 1, the brine temperature inside the evaporator according to changes in brine concentration in the adsorption desalination (concentration) process included in the ultra-high-concentration seawater desalination process (100) for valuable mineral recovery and high-purity freshwater production according to a preferred embodiment of the present invention can be confirmed. Unlike conventional processes (MED, MSF, MVR, RO, etc.), it has the advantage of a lower Top Brine Temperature (TBT), which allows overcoming issues such as scaling and cleaning, enabling ultra-high concentration of seawater.

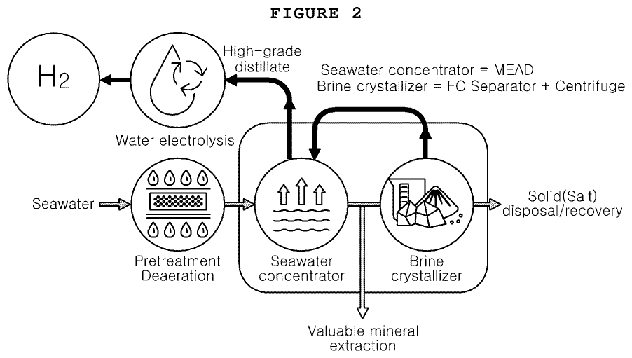

Referring to FIG. 2, the ultra-high-concentration seawater desalination process (100) for valuable mineral recovery and high-purity freshwater production according to a preferred embodiment of the present invention is characterized by introducing seawater through a seawater inlet; performing pre-treatment by deaerating the introduced seawater; introducing the pretreated seawater into a seawater concentrator; introducing the seawater concentrated in the seawater concentrator into a concentrated water crystallizer to extract/recover valuable minerals and to process/recover solids (salts); re-introducing the concentrated water produced in the concentrated water crystallizer into the seawater concentrator; and subjecting distilled water discharged from the seawater concentrator to electrolysis treatment (water electrolysis) to produce hydrogen (H2).

Here, the seawater concentrator comprises a multi-effect adsorption desalination (MEAD).

In addition, the concentrated water crystallizer comprises a forced circulation separator and a centrifuge.

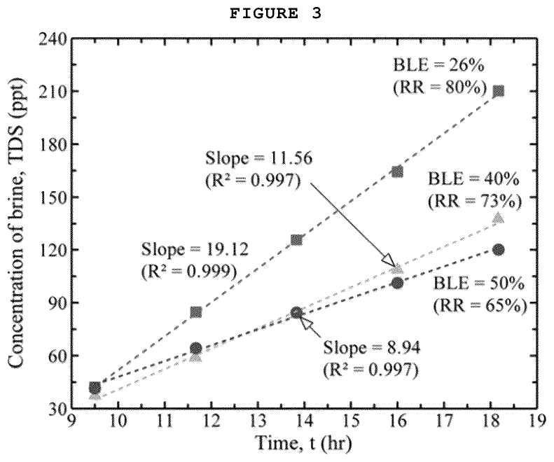

FIG. 3 is a graph showing the change in brine concentration inside the evaporator over time in the adsorption desalination process (100) included in the ultra-high-concentration seawater desalination process for valuable mineral recovery and high-purity freshwater production according to a preferred embodiment of the present invention.

Referring to FIG. 3, when observing the change in brine concentration inside the evaporator over time in the adsorption desalination process, it can be confirmed that the system performance degradation is minimal even under ultra-high-concentration seawater conditions.

In addition, the energy cost for recovering valuable minerals from ultra-high-concentration seawater is very low.

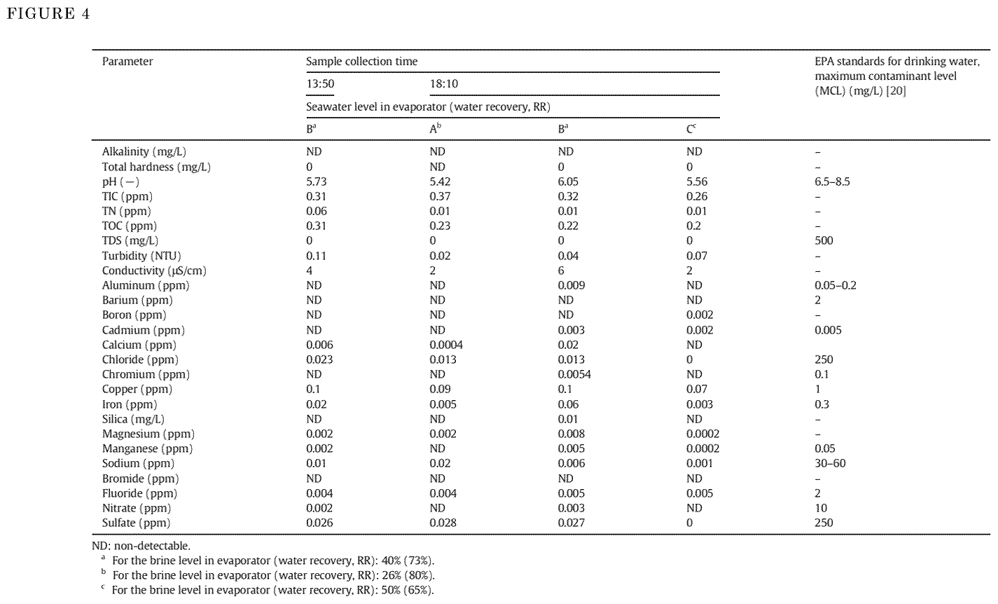

FIG. 4 is a chart showing the water quality of the freshwater produced from the adsorption desalination process (100) included in the ultra-high-concentration seawater desalination process for valuable mineral recovery and high-purity freshwater production according to a preferred embodiment of the present invention.

Referring to FIG. 4, it can be confirmed from the water quality of the freshwater produced by the adsorption desalination process that high-purity freshwater production is possible even under ultra-high-concentration seawater conditions.

Meanwhile, the present specification and drawings disclose preferred embodiments of the present invention, and although specific terms have been used, these are used merely in a general sense to facilitate explanation of the technical content of the invention and aid understanding, and are not intended to limit the scope of the invention. Besides the embodiments disclosed herein, it is evident to those skilled in the art that other variations based on the technical spirit of the present invention are also possible.

### DESCRIPTION OF REFERENCE NUMERALS

100: ULTRA-HIGH-CONCENTRATION SEAWATER DESALINATION PROCESS FOR VALUABLE MINERAL RECOVERY AND HIGH-PURITY FRESHWATER PRODUCTION

1. An ultra-high-concentration seawater desalination process for valuable mineral recovery and high-purity freshwater production, the process comprising:
introducing seawater through a seawater inlet;
performing pre-treatment by deaerating the introduced seawater;
introducing the pretreated seawater into a seawater concentrator;
introducing the seawater concentrated in the seawater concentrator into a concentrated water crystallizer to extract/recover solids (valuable mineral salts);
re-introducing the concentrated water produced in the concentrated water crystallizer into the seawater concentrator; and
subjecting distilled water discharged from the seawater concentrator to electrolysis treatment (water electrolysis) to produce hydrogen (H2).

2. The ultra-high-concentration seawater desalination process for valuable mineral recovery and high-purity freshwater production of claim 1,
wherein the seawater concentrator comprises a multi-effect adsorption desalination (MEAD).

3. The ultra-high-concentration seawater desalination process for valuable mineral recovery and high-purity freshwater production of claim 1,
wherein the concentrated water crystallizer comprises a forced circulation separator and a centrifuge.
